(19) United States
(12) Patent Application Publication
(10) Pub. No.: US 2009/0066901 A1
(43) Pub. Date: Mar. 12, 2009

(54) LIQUID CRYSTAL DISPLAY

(75) Inventors: Jiunn-Shyong Lin, Taipei County (TW); Po-Sheng Shih, Taipei County (TW); Kei-Hsiung Yang, Taipei County (TW); Tai-Shun Liao, Taipei County (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HANNSTAR DISPLAY CORPORATION, Taipei County (TW)

(21) Appl. No.: 12/100,955

(22) Filed: Apr. 10, 2008

(30) Foreign Application Priority Data
Sep. 10, 2007 (TW) 096133765

(51) Int. Cl. G02F 1/1343

(52) U.S. Cl. 349/139

(57) ABSTRACT

A liquid crystal display is provided. The liquid crystal display including a first substrate having thereon a plurality of gate lines and data lines intersected to each other, so as to form a pixel surrounded thereby, a second substrate counter to the substrate, a common electrode disposed on the first substrate and having a first portion and a slit corresponding to one of the data lines and a second portion located inside the pixel, and a pixel electrode disposed between the first portion and the second portion of the common electrode, and adjacent to the first portion. The first portion of the common electrode and the pixel electrode have a first distance d1, the second portion of the common electrode and the pixel electrode have a second distance d2, and the first distance d1 is not equivalent to the second distance d2.

### FIELD OF THE INVENTION

The present invention relates to a liquid crystal display (LCD), and more particularly to an in-plane switching (IPS) LCD.

### BACKGROUND OF THE INVENTION

The liquid crystal display (LCD) has been broadly used in various applications in the daily life with the improvement and popularity of the digital network technology. Many techniques are developed for obtaining a wider viewing angle for the LCD, among which the in-plane switching (IPS) mode is regarded as an excellent technique to achieve the mentioned purpose. In order to improve the lower aperture ratio of the IPS LCD, an improved IPS LCD structures, known as the advanced super IPS LCD (AS-IPS LCD), are disclosed in U.S. Pat. No. 6,693,687. The AS-IPS LCD improves the aperture ratio and eliminates the crosstalk effects by disposing an overcoat layer between the common electrode and the data lines on a thin film transistor (TFT) array substrate.

Although the improvement of aperture ratio and the elimination of crosstalk effect are achievable though the arrangement of the overcoat layer in the AS-IPS LCD, the application of the overcoat layer results in a significant increase in the manufacturing cost. In order to reduce the manufacturing cost, the applicant of the present invention has provided an improved Advanced Super Non-Organic Overcoat liquid crystal display (AS-NOOC LCD) structure having a steady optical property and a wide view angle without the arrangement of the organic overcoat layer on the TFT substrate.

Nevertheless, in compassion with the AS-IPS LCD, the AS-NOOC LCD has a further counter electrode disposed on the color filter (CF) substrate opposite to the array substrate, and thus the line of electric force generated by the pixel electrode, in the bright state, is almost parallel to the array substrate. Since the line of electric force generated by the pixel electrode is almost parallel to the array substrate, the homogeneously aligned liquid crystal molecules are substantially in-plain switched by the electric force, which results in a relatively higher brightness on the display region near the data lines. That is to say the AS-NOOC LCD may have a brightness uniformity issue because of the equally-spaced arrangement of the electrodes between the pixel and common electrodes. In order to overcome the mentioned drawbacks in the prior art, a novel liquid crystal display for optimizing the brightness uniformity of display is provided in the present invention.

### SUMMARY OF THE INVENTION

It is an aspect of the present invention to provide a novel liquid crystal display for optimizing the brightness uniformity of display. The liquid crystal display includes a first substrate having thereon a plurality of gate lines and data lines intersected to each other, so as to form a pixel surrounded thereby, a second substrate counter to the substrate, a common electrode disposed on the first substrate and having a first portion having a slit corresponding to one of the data lines and a second portion located inside the pixel, and a pixel electrode disposed between the first portion and the second portion of the common electrode, and adjacent to the first portion, wherein the first portion of the common electrode and the pixel electrode have a first distance d1, the second portion of the common electrode and the pixel electrode have a second distance d2, and the first distance d1 is not equivalent to the second distance d2.

Preferably, the first distance d1 is lager than the second distance d2.

Preferably, a ratio of the first distance d1 to the second distance d2 is defined by equation: 1<d1/d2≦2.

Preferably, a ratio of the first distance d1 to the second distance d2 is defined by equation: 1<d1/d2≦1.3.

Preferably, a difference between the first distance d1 and the second distance d2 is defined by equation: 0<|d1−d2|≦10 μm.

Preferably, the difference between the first distance d1 and the second distance d2 is defined by equation: 1≦|d1−d2|≦3.5 μm.

Preferably, the liquid crystal display further includes a pair of shielding electrodes disposed on the first substrate, wherein the data line is disposed between the pair of shielding electrodes.

Preferably, the shielding electrodes are floating.

Preferably, the shielding electrodes are electrically connected to a common voltage.

Preferably, the liquid crystal display further includes a counter electrode disposed on the second substrate and corresponding to one of the data lines.

Preferably, the counter electrode is an opaque electrode.

Preferably, the counter electrode is a transparent electrode.

Preferably, the liquid crystal display further includes a BM resin layer disposed between the second substrate and the counter electrode.

Preferably, the liquid crystal display further includes a BM resin layer disposed on the counter electrode.

Preferably, the counter electrode is electrically connected to a common voltage.

Preferably, the counter electrode is electrically connected to a fixed voltage.

Preferably, the liquid crystal display further includes a color filter layer disposed on the second substrate.

Preferably, the liquid crystal display further includes an overcoat layer disposed on the color filter layer.

In accordance with the aspect of the present invention, a further novel liquid crystal display for optimizing the brightness uniformity of display. The liquid crystal display includes a pixel and a data line disposed on a substrate, a common electrode disposed on the substrate and having a first portion having a slit corresponding to the data line and a second portion located inside the pixel, and a pixel electrode disposed between the first portion and the second portion of the common electrode, and adjacent to the first portion, wherein the first portion of the common electrode and the pixel electrode form a first display region, the second portion of the common electrode and the pixel electrode form a second display region, and the first display region has a geometry different from what the second display region has.

Preferably, the geometry is referred to an area.

Preferably, the geometry is referred to a width.

Preferably, the geometry is referred to a shape.

Preferably, the common electrode and the pixel electrode are coplanar.

The foregoing and other features and advantages of the present invention will be more clearly understood through the following descriptions with reference to the drawings, wherein:

### BRIEF DESCRIPTION OF THE DRAWINGS

FIG. 1 is a cross-sectional view schematically showing the structure of a LCD according to a first embodiment of the present invention;

FIG. 2 is a diagram showing the relationship between the maximum transmittance and the difference between the first distance d1 and the second distance d2 in different BM shifts;

FIG. 3 is a cross-sectional view schematically showing the structure of a LCD according to a second embodiment of the present invention;

FIG. 4 is a cross-sectional view schematically showing the structure of a LCD according to a third embodiment of the present invention;

FIG. 5 is a cross-sectional view schematically showing the structure of a LCD according to a fourth embodiment of the present invention; and

FIG. 6 is a cross-sectional view schematically showing the structure of a LCD according to a fifth embodiment of the present invention;

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

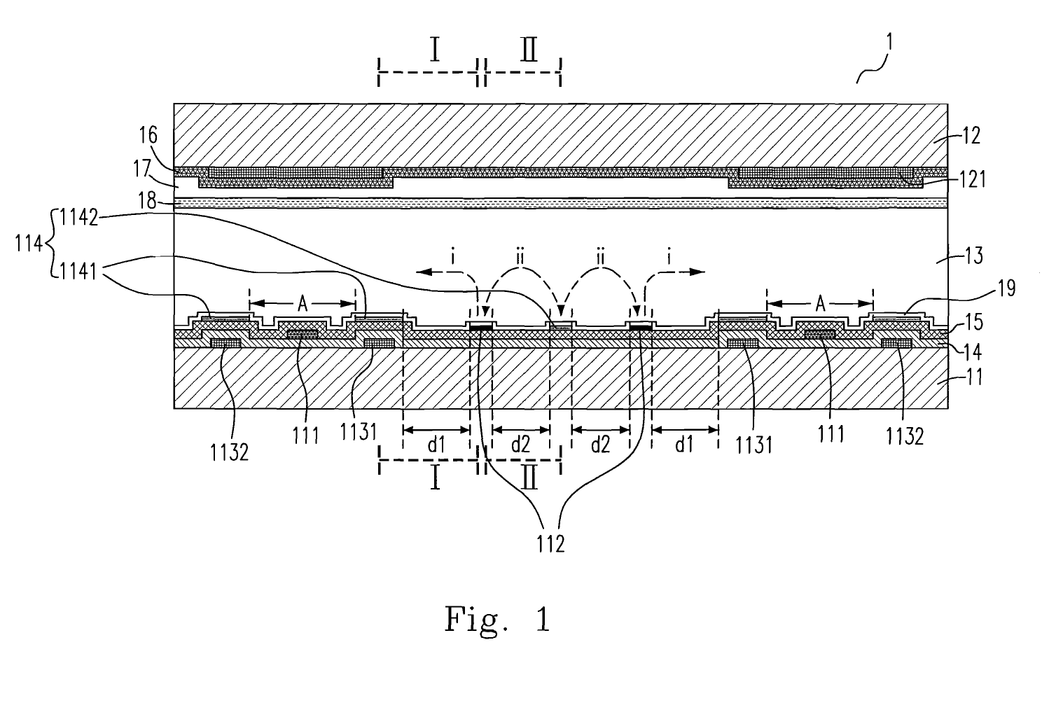

Please refer to FIG. 1, which schematically shows a cross-sectional view of the structure of a LCD according to a first embodiment of the present invention. As shown in FIG. 1, the LCD 1 of the present invention include a first substrate 11, a second substrate 12 opposite to the first substrate 11 and a liquid crystal layer 13 disposed therebetween. A counter electrode 121 is disposed on a side of the second substrate 12 facing to the first substrate 11. In the first embodiment of the present invention, the counter electrode 121 is an opaque electrode connected to a fixed voltage, such as a common electrode. Further, on the second substrate 12, a color filter layer 16, an overcoat layer 17 and an alignment layer 18 are sequentially formed on the counter electrode 121. On the other hand, a pair of shielding electrodes 1131 and 1132, which are floating or electrically connected to a common voltage, are formed on the side of the first substrate facing to the second substrate 12. Further, a gate insulation layer 14, a plurality of data lines 111 and a passivation layer 15 are sequentially formed on the gate insulation layer 14, and a pixel electrode 112 and a common electrode 114 are coplanar and respectively disposed on the passivation layer 15. The common electrode 114 has a first portion 1141 and a second portion 1142, wherein the first portion 1141 of the common electrode 114 has a slit corresponding to the location of the data line 111. Further, the pixel electrode 112 and the common electrode 114 are covered with an alignment layer 19. Specifically, the substrate 11 includes a plurality of pixels surrounded by the intersected gate lines and data lines, and the pixel electrode 112 and the second portion 1142 of the common electrode 114 are located inside the pixel.

According to the first embodiment of the present invention, the pixel electrode 112 is disposed between the first portion 1141 of the common electrode 114 and the second portion 1142 of the common electrode 114, and the distance from the first portion 1141 of the common electrode 114 to the adjacent pixel electrode 112 is defined as a first distance d1, and the distance from the second portion 1142 of the common electrode 114 to the adjacent pixel electrode 112 is defined as a second distance d2, which are respectively corresponding to a first display region I and a second display region II as shown in FIG. 1. On the co-effect of the common electrode and the counter electrode, the force of the electric field in the first display region is almost parallel to the substrate, so that the liquid crystals in the first region I have the maximum optical efficiency, while the force of the electric field in the second display region II are not affected by the counter electrode.

According to the aspect of the present invention, the force of the electrode field in the first and the second display regions I and II can be adjusted by the first distance d1 between the first portion 1141 of the common electrode 114 and the adjacent pixel electrode 112 and the second distance d2 between the second portion 1142 of the common electrode 114 and the adjacent pixel electrode 112. In the first embodiment of the present invention, the first distance d1 and the second distance d2 are not equaled. Preferably, the first distance d1 are lager than the second distance d2, and relationship between the first distance d1 and the second distance d2 can be defined by the following equations:

1<d1/d2≦2; or, preferably

1<d1/d2≦1.3.

0<|d1−d2|≦10 μm; or preferably

1≦|d1−d2|≦3.5 μm.

Therefore, according to the present invention, the first display region I has a geometry (such as, area, shape or width) different from what the second display region II has.

However, the technical feature descried in the first embodiment of the present invention is an example for practicing the present invention. The actual deployment of the electrodes can be adjusted as desired. For example, the common electrode 114 and the pixel electrode 112 might not be alternately disposed, nor disposed coplanarily.

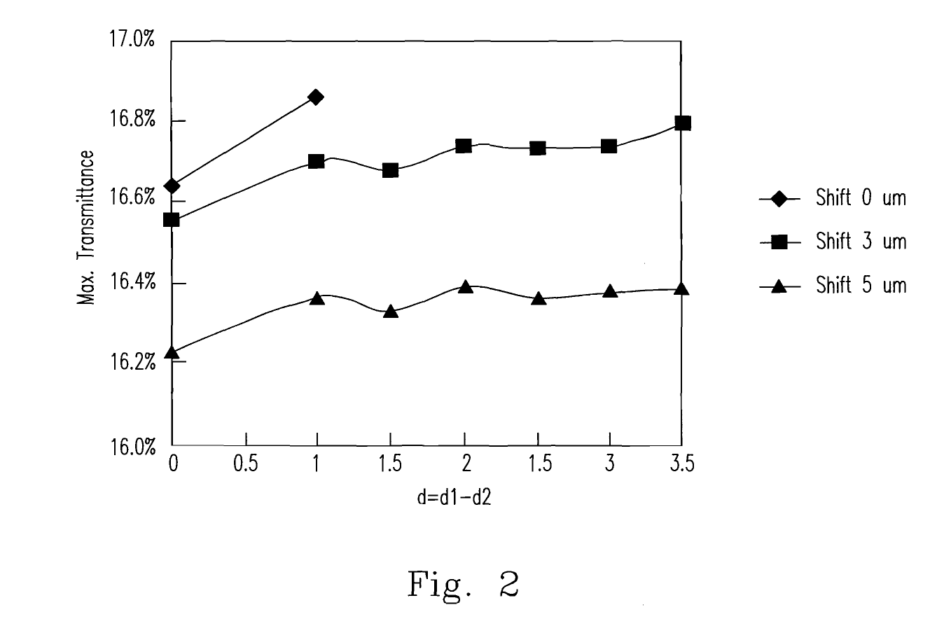

Please refer to FIG. 2, which is a diagram showing the relationship between the maximum transmittance and the difference between the first distance d1 and the second distance d2 in different BM shifts according to the first embodiment of the present invention. As shown in FIG. 2, the optical transmittance of the liquid crystal display of the present invention is increased with the increasing of the difference between the first distance d1 and the second distance d2. Further, even though the black matrix is shifted to 5 μm, the transmittance of the LCD of the present invention still approaches to 16.4%. Accordingly, in comparison with the conventional IPS LCD or AS-IPS LCD, the LCD of the present invention has a better optical transmittance in the same driving voltage, even though consideration of the BM shift effects, which are inevitable in the assembly process of the LCD.

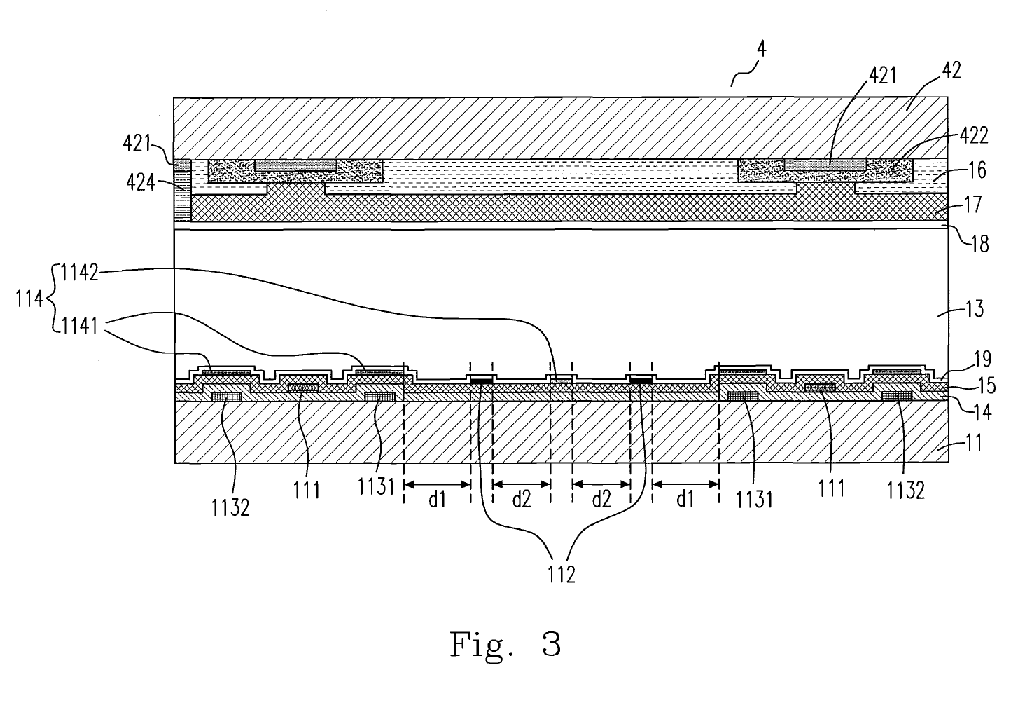

According to the present invention, the counter electrode of the LCD can also be a transparent electrode. Please refer to FIG. 3, which schematically shows a cross-sectional view of the structure of a LCD according to a second embodiment of the present invention. In comparison with the LCD according to a first embodiment of the present invention, the counter electrode 421 on the second substrate 42 of the LCD 4 is formed by a transparent electrode, and black matrix resin layer 422 is disposed on the counter electrode 421 for blocking the light transmitting therethrough. Further, in the second embodiment, the LCD has a color filter 16 and an overcoat layer 17, and a through hole 424 is used for electrically connecting the counter electrode 421 to a proper voltage.

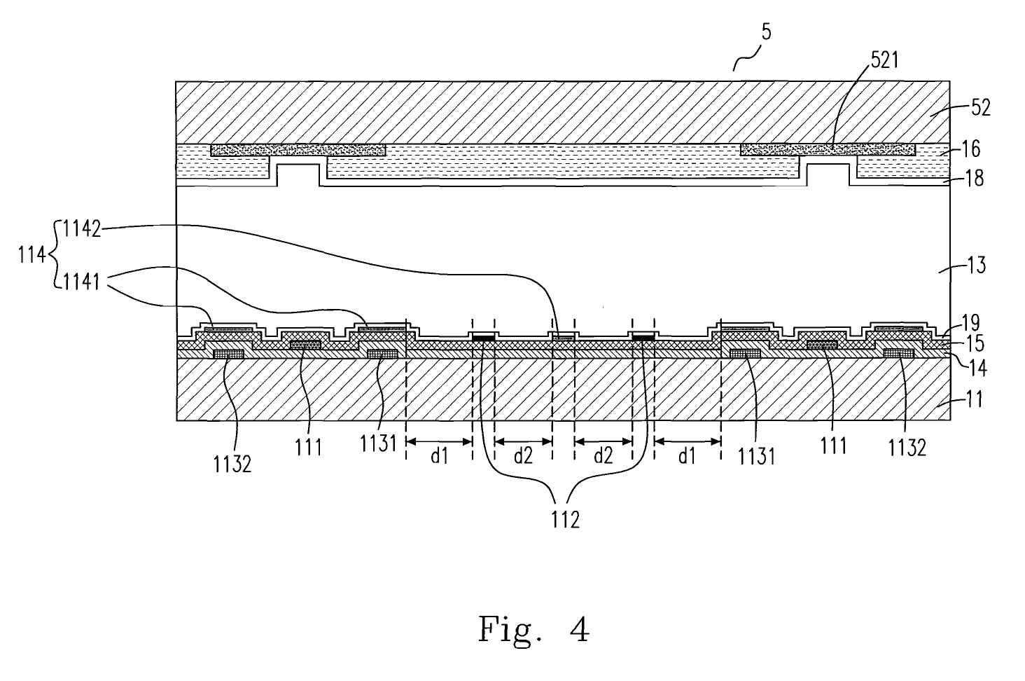

Please refer to FIG. 4, which schematically shows a cross-sectional view of the structure of a LCD according to a third embodiment of the present invention. In comparison with the LCD according to the previous embodiments of the present invention, the counter electrode 521 on the second substrate 52 of the LCD 5 is formed by an opaque conductive material, such as, the chromium. Nevertheless, in this embodiment, no overcoat layer is formed on the second substrate.

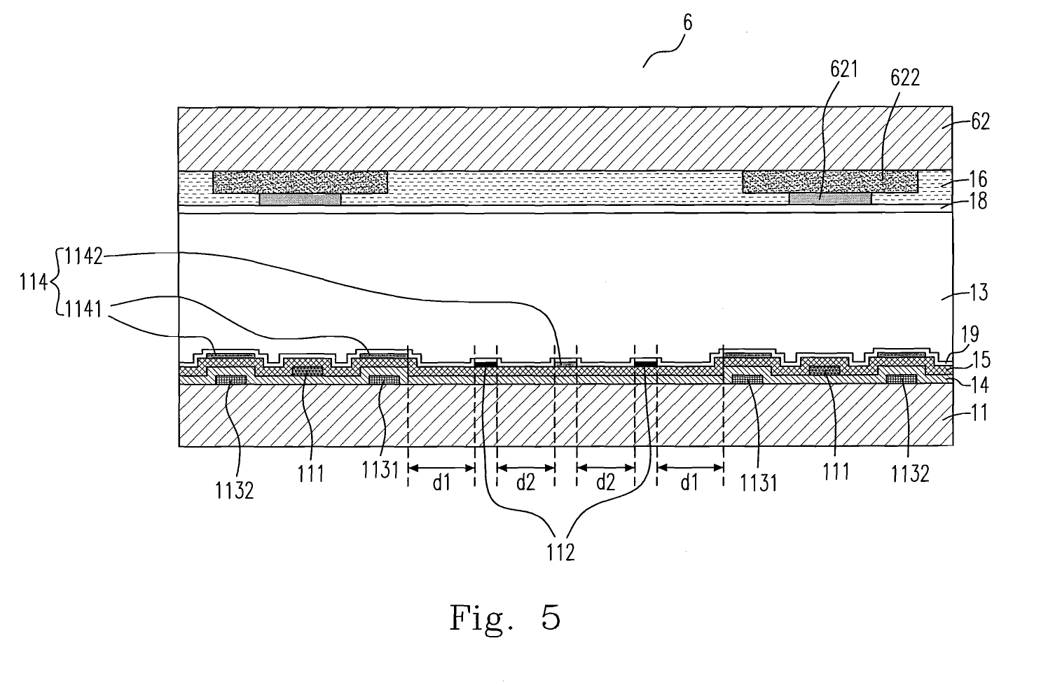

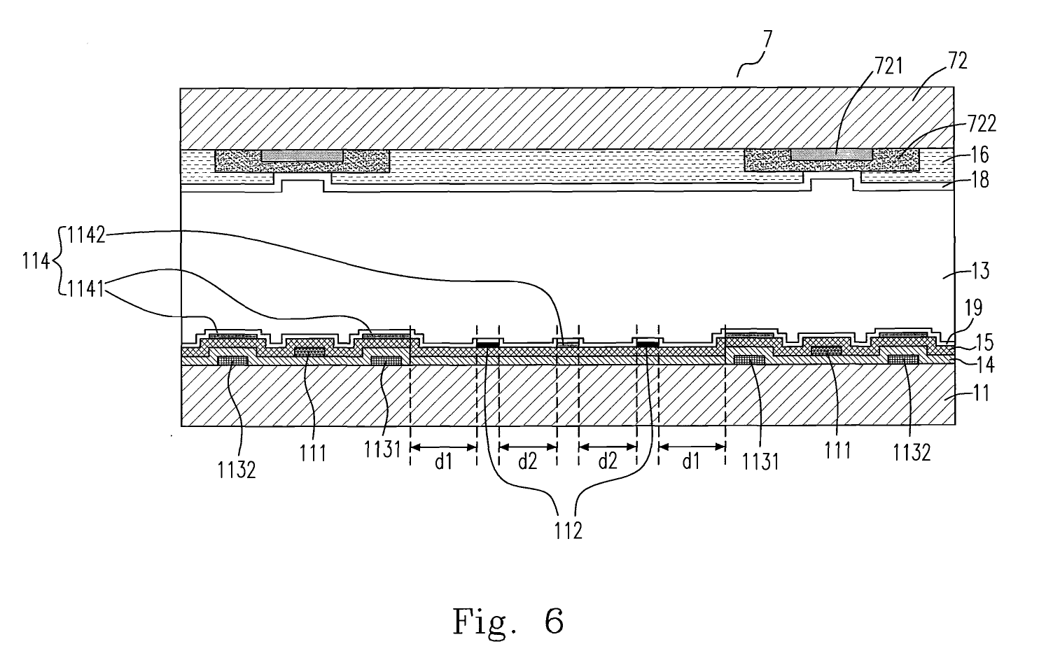

Please refer to FIGS. 5 and 6, which respectively show a cross-sectional view of the structure of a LCD according to a fourth and fifth embodiments of the present invention. In comparison with the LCD according to the previous embodiments of the present invention, the LCD according to a fourth and fifth embodiments of the present invention have the different arrangements for the counter electrodes 621, 721 and the black matrix resin layers 622, 722. As shown in FIG. 5, the second substrate 62 of the LCD 6 has thereon a black matrix resin layer 622, and then a transparent counter electrode 621 is formed on the black matrix resin layer 622. While, as shown in FIG. 6, the second substrate 72 of the LCD 7 has thereon a transparent counter electrode 721, and then a black matrix resin layer 722 is formed on the transparent counter electrode 721. Moreover, in comparison with the first embodiment of the present invention, the LCDs 6 and 7 according to the fourth and fifth embodiments of the present invention has no overcoat layer formed on the respective second substrate layers 62 and 72.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A liquid crystal display comprising:
a first substrate comprising thereon a plurality of gate lines and data lines intersected to each other, so as to form a pixel surrounded thereby;
a second substrate opposite to the first substrate;
a common electrode disposed on the first substrate and having a first portion and a second portion, wherein the first portion has a slit corresponding to one of the data lines, and the second portion is located inside the pixel; and
a pixel electrode disposed between the first portion and the second portion of the common electrode, and adjacent to the first portion,
wherein the first portion of the common electrode and the pixel electrode have a first distance d1, the second portion of the common electrode and the pixel electrode have a second distance d2, and the first distance d1 is not equivalent to the second distance d2.

2. A liquid crystal display according to claim 1, wherein the first distance d1 is lager than the second distance d2.

3. A liquid crystal display according to claim 1, wherein a ratio of the first distance d1 to the second distance d2 is defined by equation: 1<d1/d2≦2.

4. A liquid crystal display according to claim 1, wherein a difference between the first distance d1 and the second distance d2 is defined by equation:
0<|d1−d2|≦10 μm.

5. A liquid crystal display according to claim 4, wherein the difference between the first distance d1 and the second distance d2 is defined by equation: 1<|d1-d2|<3.5 μm.

6. A liquid crystal display according to claim 1, further comprising a pair of shielding electrodes disposed on the first substrate, wherein the data line is disposed between the pair of shielding electrodes.

7. A liquid crystal display according to claim 6, wherein the shielding electrodes are floating.

8. A liquid crystal display according to claim 6, wherein the shielding electrodes are electrically connected to a common voltage.

9. A liquid crystal display according to claim 1, further comprising a counter electrode disposed on the second electrode and corresponding to one of the data lines.

10. A liquid crystal display according to claim 9, wherein the counter electrode is an opaque electrode.

11. A liquid crystal display according to claim 9 wherein the counter electrode is a transparent electrode.

12. A liquid crystal display according to claim 11, further comprising a BM resin layer disposed between the second substrate and the counter electrode.

13. A liquid crystal display according to claim 11, further comprising a BM resin layer disposed on the counter electrode.

14. A liquid crystal display according to claim 9, wherein the counter electrode is electrically connected to a common voltage.

15. A liquid crystal display according to claim 14, wherein the counter electrode is electrically connected to a fixed voltage.

16. A liquid crystal display according to claim 1, further comprising a color filter layer disposed on the second substrate.

17. A liquid crystal display according to claim 16, further comprising an overcoat layer disposed on the color filter layer.

18. A liquid crystal display comprising:
a pixel and a data line disposed on a substrate;
a common electrode disposed on the substrate and having a first portion and a second portion, wherein the first portion has a slit corresponding to the data line, and the second portion is located inside the pixel; and
a pixel electrode disposed between the first portion and the second portion of the common electrode, and adjacent to the first portion,
wherein the first portion of the common electrode and the pixel electrode form a first display region, the second portion of the common electrode and the pixel electrode form a second display region, and the first portion has a geometry different from what the second portion has.

19. A liquid crystal display according to claim 18, wherein the geometry is referred to an area.

20. A liquid crystal display according to claim 18, wherein the geometry is referred to a width.

21. A liquid crystal display according to claim 18, wherein the geometry is referred to a shape.

22. A liquid crystal display according to claim 18, wherein the common electrode and the pixel electrode are coplanar.
